(19) United States
(12) Patent Application Publication
(10) Pub. No.: US 2010/0045003 A1
(43) Pub. Date: Feb. 25, 2010

(54) AIRBAG MOUNTING SYSTEM AND METHOD

(75) Inventor: GEOFFREY MILLS, Lake Orion, MI (US)

Correspondence Address: AUTOLIV ASP INC, 3350 AIRPORT ROAD, OGDEN, UT, 84405, US

(73) Assignee: AUTOLIV ASP, INC., Ogden, UT (US)

(21) Appl. No.: 12/195,145

(22) Filed: Aug. 20, 2008

(51) Int. Cl. B60R 21/16

(52) U.S. Cl. 280/728.2

(57) ABSTRACT

An inflatable airbag cushion assembly with an inflatable cushion membrane that has attachment flaps that are received by an attachment interface. An inflator can be mounted on the attachment interface such that the cushion membrane retention flaps are anchored to the attachment interface.

### TECHNICAL FIELD

The present disclosure relates generally to the field of automotive protective systems. More specifically, the present disclosure relates to an airbag assembly, wherein the inflatable cushion membrane is configured to be attached with an interface without the use of a retaining ring.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the disclosure's scope, the embodiments will be described and explained with specificity and detail in reference to the accompanying drawings.

FIG. 1 is a perspective view of a portion of one embodiment of an airbag assembly.

FIG. 2 is another perspective view of the airbag assembly of FIG. 1.

FIG. 3 is a perspective view of the airbag assembly of FIG. 1 after flaps in an airbag have been received by an airbag attachment interface.

FIG. 4 is a perspective view of the airbag assembly of FIG. 3, wherein an inflator is ready to be coupled to an attachment interface.

FIG. 5 is a side elevation cross section view of the airbag assembly of FIG. 4 after the inflator has been coupled to the attachment interface and the flaps have been folded over.

FIG. 6 is a cross sectional view of another embodiment of an airbag assembly.

FIG. 7 is a perspective view of yet another embodiment of an airbag assembly.

### INDEX OF ELEMENTS IDENTIFIED IN THE DRAWINGS

100 inflatable cushion airbag assembly
110 cushion membrane
111 throat portion
112 inlet aperture of cushion
120 attachment flap
121 body portion of flap
122 base portion of flap
123 end portion of flap
124 mounting apertures
125 stitching
127 terminal portion
130 attachment interface
131 front face
132 rearface
133 slots
135 gas inlet opening
136 deflectors
137 mounting stem
138 topographical feature
139 mounting structures
140 inflator
141 body portion
142 vents
143 plate portion
144 mounting apertures
200 inflatable cushion airbag assembly
210 cushion membrane
211 throat portion
212 inlet aperture of cushion
220 attachment flap
221 body portion of flap
222 base portion of flap
223 end portion of flap
224 mounting apertures
230 attachment interface
231 front face
232 rearface
233 slots
235 gas inlet opening
236 deflectors
237 mounting stem
240 inflator
241 body portion
242 vents
243 plate portion
244 mounting apertures
247 mounting hardware
251 walls of interface
252 cosmetic cover
300 inflatable cushion airbag assembly
310 cushion membrane
311 throat portion
312 inlet aperture of cushion
320 attachment flap
321 body portion of flap
322 base portion of flap
323 end portion of flap
324 mounting apertures
325 stitching
327 terminal portion
330 attachment interface
331 front face
332 rearface
333 slots
335 gas inlet opening
336 deflectors
337 mounting stem
338 topographical feature
339 mounting structures

### DETAILED DESCRIPTION OF PREFERRED EMBODIMENTS

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together.

Inflatable airbag systems are widely used to minimize occupant injury in a collision scenario. Airbag modules have been installed at various locations within a vehicle, including, but not limited to, the steering wheel, the instrument panel, within the side doors or side seats, adjacent to roof rail of the vehicle, in an overhead position, or at the knee or leg position. In the following disclosure, “airbag” may refer to an inflatable curtain airbag, overhead airbag, front airbag, or any other airbag type.

Front airbags are typically installed in the steering wheel and instrument panel of a vehicle. During installation, the airbags are rolled, folded, or both, and are retained in the rolled/folded state behind a cover. During a collision event, vehicle sensors trigger the activation of an inflator, which rapidly fills the airbag with inflation gas. Thus the airbag rapidly changes confirmations from the rolled/folded configuration to an expanded configuration.

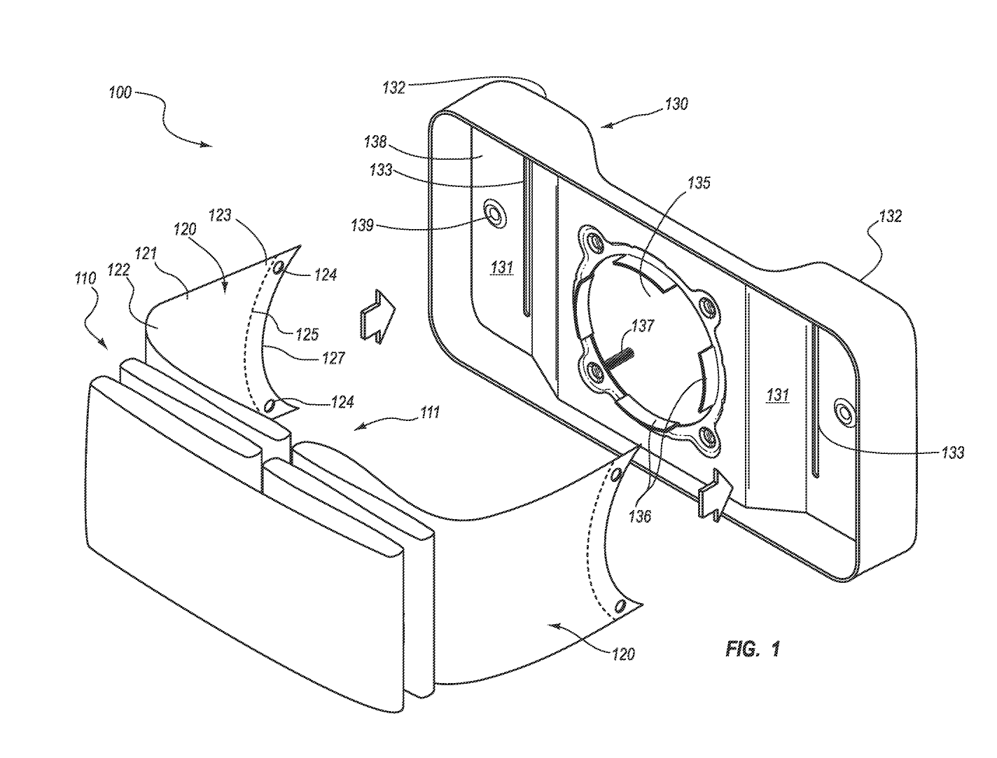

FIGS. 1-4 depict various views of airbag assembly 100, wherein FIG. 1 is a front perspective view. Airbag assembly 100 may comprise an inflatable cushion membrane 110, an attachment interface 130, and an inflator 140. Airbag assembly 100 is configured such that the cushion membrane is has a plurality of flaps that may be received by a corresponding number of slots in the attachment interface. The flaps are configured to protrude through the slots in the attachment interface such that they can be folded against a back face of the attachment interface and be secured thereto by the inflator.

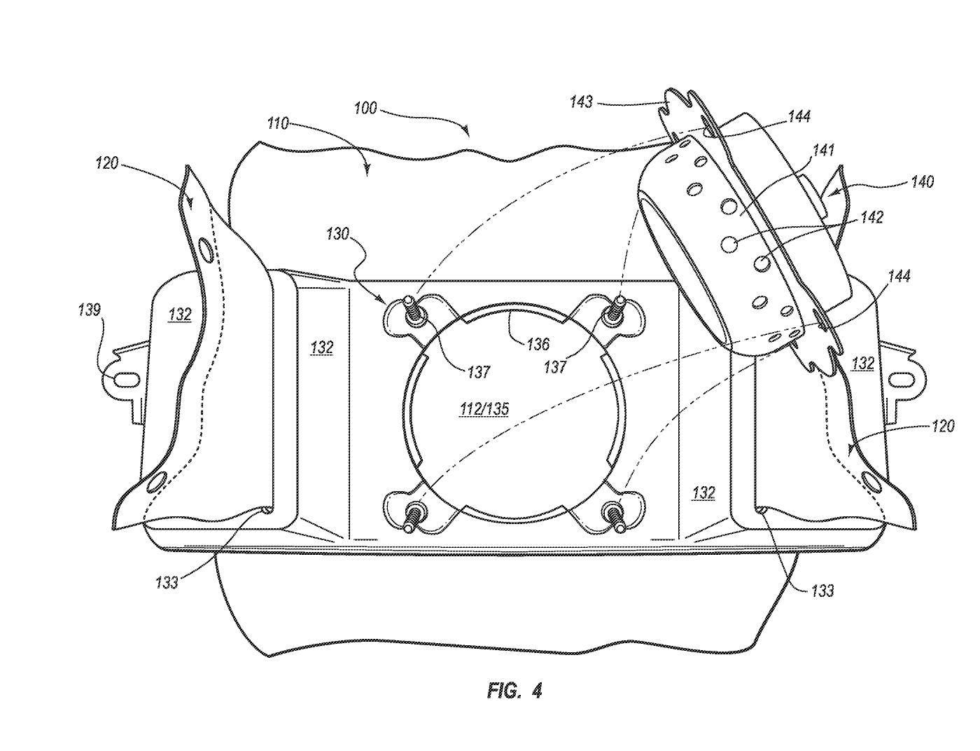

According to the embodiment depicted in FIG. 1, inflatable airbag cushion 110 comprises a throat portion 111, that is configured to allow the cushion to be coupled to attachment interface 130, wherein the throat portion comprises an aperture for receiving inflation gas from an inflator (not shown) and a plurality of flaps 120. Cushion 110 may further comprise a front face 113 and other portions that are not depicted in FIG. 1, such as an upper portion, a lower portion, a rear face, a first side face, and a second side face. The various faces of cushion membrane 110 define an interior inflatable void. When membrane 110 is coupled to attachment interface 130, as described herein, the inflatable void may be in fluid communication with an inflator 140 (FIG. 4).

FIG. 1 depicts two flaps 120 that are very similar, and are primarily distinguished by their different positions on cushion 110. Each of the flaps may further comprise a body 121, a base portion 122, and an end portion 123. Flap 120 may comprise a plurality of apertures 124. Since there is not structural demarcation between the body portion and base portion of the flap, the apertures may be said to be located on either the body portion 121 and/or end portion 123. The apertures are configured to receive mounting hardware so that flap 120 can be coupled to attachment interface 130. In the depicted embodiment, body portion 121 comprises a generally rectangular shape that protrudes from cushion 110 sufficient to be received by and coupled to attachment interface 130. One skilled in the art will recognize that a variety of shapes of flaps may be employed, and the shape of flap 130 depicted in FIG. 1 is for illustrative purposes only. Base portion 122 may comprise an extension of cushion 110, wherein the base portion is contiguous with a side or rear face of cushion 110, or alternatively the base portion may comprise an area that overlaps with cushion 110 such that flap 120 can be coupled to the cushion at the base portion. The base portion may not be distinguished from the body portion of the flap, except the base portion is adjacent to the cushion membrane.

End portion 123 may be generally defined as the area of a flap that is distal to base portion 122 and may comprise stitching 125, which may reinforce the end portion by coupling together two or more pieces of material. End portion 123 may comprise stitching 125, apertures 124, and a terminal portion 127. Apertures 124 may be positioned to receive mounting hardware attached to a rear face of attachment interface 130. In the depicted embodiment, terminal portion 127 comprises a semicircular shape such that end portion 123 may be called a semicircular end portion.

As noted above the flap may comprise a contiguous extension of the inflatable airbag cushion, or may comprise a separate piece attached to the cushion. The flap may comprise the same fabric from which the cushion membrane is manufactured, or the flap may be a different material, such as plastic, or a different fabric. Further, the flap may comprise fabric that is at least partially reinforced by additional layers of fabric or plastic or metal. For example, the end portion of the flap may be reinforced, or the apertures may be reinforced with metal or plastic grommets. The flap may be coupled to the cushion membrane by employing a variety of techniques or structures, including sewing, gluing, and RF welding.

FIG. 1 depicts attachment interface 130 from a perspective view in which various elements of the interface are visible, such as a front face 131, slots 133, a gas inlet opening 135, deflectors 137, one of a plurality of mounting stems 137, an topographical feature 138, and a plurality of mounting structures 139. Attachment interface 130 may comprise one or more stamped or molded pieces of metal such as steel or aluminum.

Front face 131 is configured to be directed toward cushion membrane 110 throat portion 111. Slots 133 are depicted as elongated apertures that extend through attachment interface 130. The width and height of slots 133 are of sufficient magnitude to allow each flap 120 to be received by a slot such that the flaps protrude through the slots. Gas inlet opening 135 is configured such that it may receive a portion of an inflator and/or inflation gas from the inflator. The diameter of inlet opening 135 is sufficient to receive the inflator and/or inflation gas. Deflectors 136 may comprise extensions of attachment interface 130, or alternative, separate pieces that are coupled to the interface. The deflectors alter the direction of inflation gas toward or away from predetermined portions of membrane 110. The deflectors may be configured as an interrupted rim as depicted in FIG. 1, or a contiguous rim.

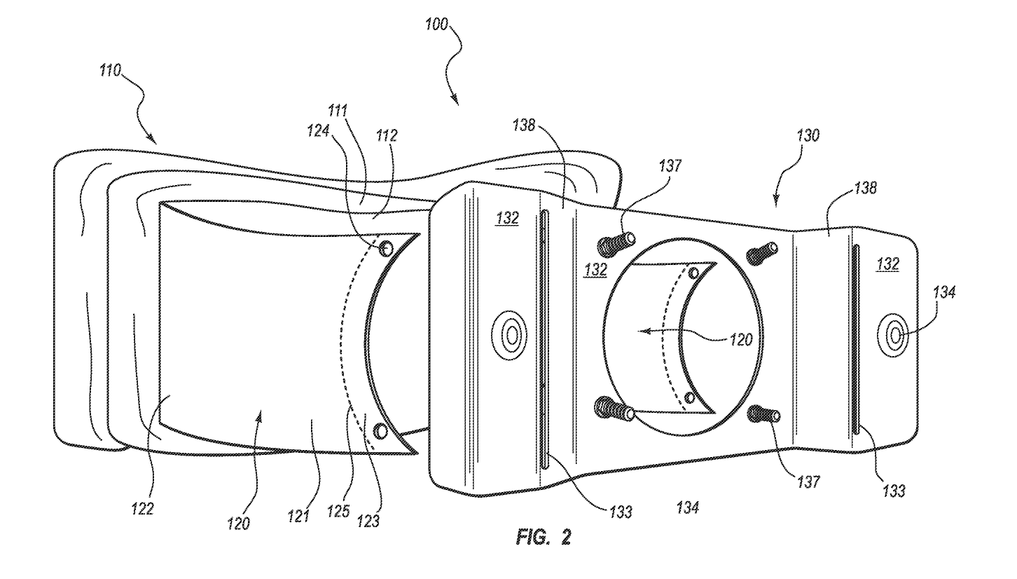

Mounting stem 137 depicted in FIG. 1 is one of a plurality of such stems that are coupled to attachment interface 130 and project rearward away from a rear face of the interface (as seen in FIG. 2). The mounting stems are configured to protrude through apertures 124 in the flaps 120 and apertures in the inflator, as seen in FIG. 4. Attachment interface 130 may also comprise one or more topographical features. These features may be configured to allow the attachment interface to achieve a predetermined orientation when used with a predetermined vehicle environment. For example, the topographical features may allow the attachment interface to be used within a specific year, make, and model of vehicle. In the depicted embodiment, two such topographical features are depicted in FIG. 1 at reference number 138. Mounting structures 139 may comprise apertures for receiving mounting hardware such that attachment interface 130 can be coupled to a vehicle structure.

As will be appreciated by those skilled in the art, a variety of types and configurations of attachment interfaces can be utilized without departing from the scope and spirit of the present disclosure. For example, in the depicted embodiment, the overall shape of the attachment interface is of a narrow rectangle, but in alternative embodiments, the shape of the interface may be more square, round, oval, or any other suitable shape. Likewise, the characteristics of any topographical features may vary from that depicted, or in some embodiments, the attachment interface may lack topographical features altogether. The shapes, sizes, and location of the slots, apertures, gas inlet opening, deflectors, mounting stems, and mounting structures may vary from those depicted, as it is contemplated that the attachment interface may be configured differently for use in different vehicle environments. The material or materials comprising the attachment interface may likewise vary and may include one or more pieces of plastic or a combination of metal and plastic.

As will be appreciated by those skilled in the art, a variety of types and configurations of airbag cushion membranes can be utilized without departing from the scope and spirit of the present disclosure. For example, the size, shape, and proportions of the cushion membrane may vary according to its use in different vehicles or different locations within a vehicle such that the cushion may comprise an inflatable curtain cushion; a rear passenger side airbag; a driver's airbag; and/or a front passenger airbag. Also, the cushion membrane may comprise one or more pieces of any material well known in the art, such as a woven nylon fabric. Additionally, the airbag cushion may be manufactured using a variety of techniques such as one piece weaving, cut and sew, or a combination of the two techniques. Further, the cushion membrane may be manufactured using sealed or unsealed seams, wherein the seams are formed by stitching, adhesive, taping, radio frequency welding, heat sealing, or any other suitable technique or combination of techniques.

FIG. 2 is a rear perspective view of airbag assembly 100. Throat portion 111 and gas inlet aperture 112 of membrane 110 are more visible in this view. Also depicted are body portion 121, base portion 122 and end portion 123 of membrane 110. As noted above, flap 120 also comprises stitching 125. The semicircular terminal portion 127 of end portion 123 is in position to be placed through slot 133 of attachment interface 130. FIG. 2 also depicts rear face 132 of attachment interface 130, in which slots 133, gas inlet opening 135, mounting stems 137, topographical features 138, and mounting structures 139 are visible.

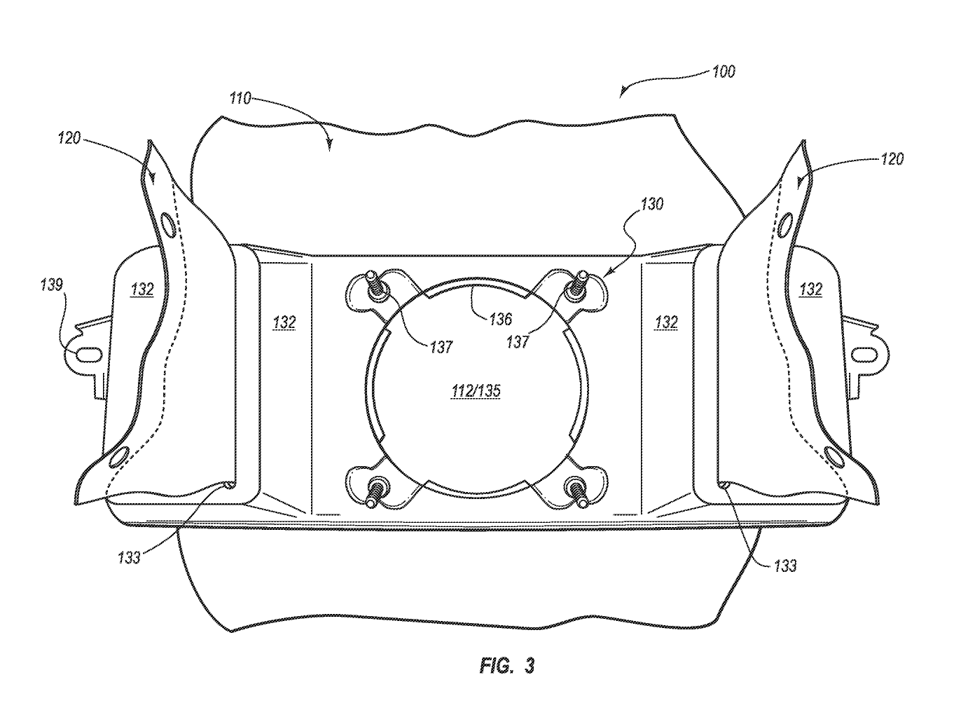

FIG. 3 is a rear perspective view of airbag assembly 100 and shows a rear face 132 of attachment interface 130. Flaps 120 of cushion membrane 110 have been placed through slots 133 of attachment interface 130 such that the throat portion (not visible) of the cushion has been pulled directly adjacent the front face of attachment interface 130. Gas inlet aperture 112 of cushion 110 is at least partially aligned with gas inlet opening 135 of attachment interface 130 such that fluid communication to the inflatable void of the cushion is possible via inlet opening 135. Also visible in this view are optional mounting structures 139.

FIG. 4 is a rear perspective view of airbag assembly 100, wherein flaps 120 of cushion membrane 110 have been received by attachment interface slots 133, and inflator 140 is ready to be coupled to the attachment interface. Inflator 140 may comprise a disk-type inflator with a body portion 141, inflation gas vents 142, a plate portion 143, and mounting apertures 144. Body portion 141 is configured to be received by gas inlet opening 135 until plate portion 143 abuts rear face 132 of attachment interface 130. Mounting apertures 144 are configured to be received by mounting stems 137. Inflator 140 may be at least partially secured to attachment interface 130 by applying mounting hardware that is complementary to mounting stems 137, such as a threaded nut or a threaded nut and washer.

One skilled in the art will appreciate that a variety of types and configurations of inflators may be used in conjunction with the attachment interface and the inflatable cushion membrane. For example, the particular shape and configuration of the inflator depicted in FIG. 4 may vary, and further, the way in which inflator 140 and attachment interface 130 interact as depicted are strictly for illustrative purposes and may vary according to different embodiments.

The inflator is configured to be activated in response to predetermined vehicle conditions as determined by vehicle sensors, with which the inflator is in electronic communication. Upon activation, the inflator rapidly generates or releases inflation gas, which forces the airbag cushion through the cosmetic cover and rapidly inflates the cushion. The inflator may be one of several types, such as pyrotechnic, stored gas, or a combination inflator; additionally, the inflator may comprise a single or multistage inflator. The inflator may be configured as a disk shaped or a tubular shaped inflator.

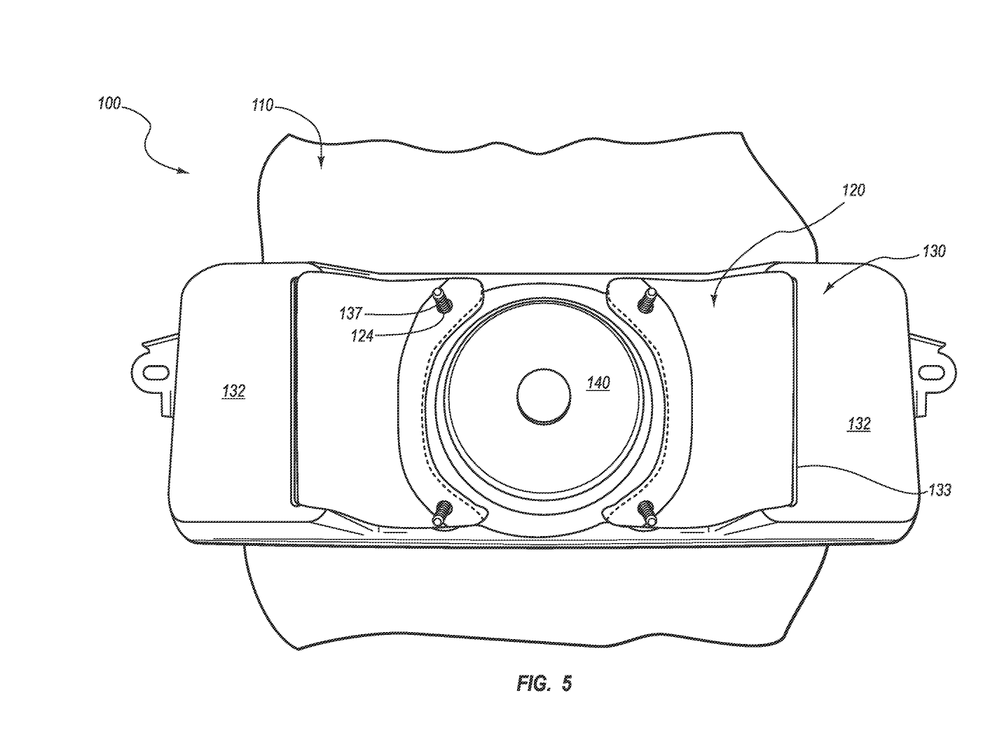

FIG. 5 is a rear perspective view of airbag assembly 100 after inflator 140 has been received by the gas inlet opening of attachment interface 130. Flaps 120 of cushion membrane 110 have been fully pulled through slots 133 in the interface and apertures 124 of the flaps have been placed over attachment interface mounting stems 137. The length of flaps 120 are predetermined such that when apertures 124 have been placed over mounting stems 137, the cushion membrane 110 is fixedly retained in a predetermined position relative to the attachment interface and inflator. When flap apertures 124 have been placed over attachment interface 130, mounting stems 137 and flaps 120 are positioned appropriately, the body portion of the flaps may lay substantially flat against the attachment interface rear face 132 and/or the inflator plate (not visible in FIG. 5).

One skilled in the art will recognize that since topographical features may be formed in the attachment interface, the topographical features may preclude the flaps from laying directly against the attachment interface rear face and/or inflator mounting plate. In this case, it may be said that the flaps lay generally parallel with the attachment interface rear face and/or inflator plate; however, as noted above, topographical features, or a lack of topographical features in the interface may result in the rear face of the interface not being planar. Further, the topographical features may cause one or more portions of the cushion flap to be higher or lower than other portions of the flap.

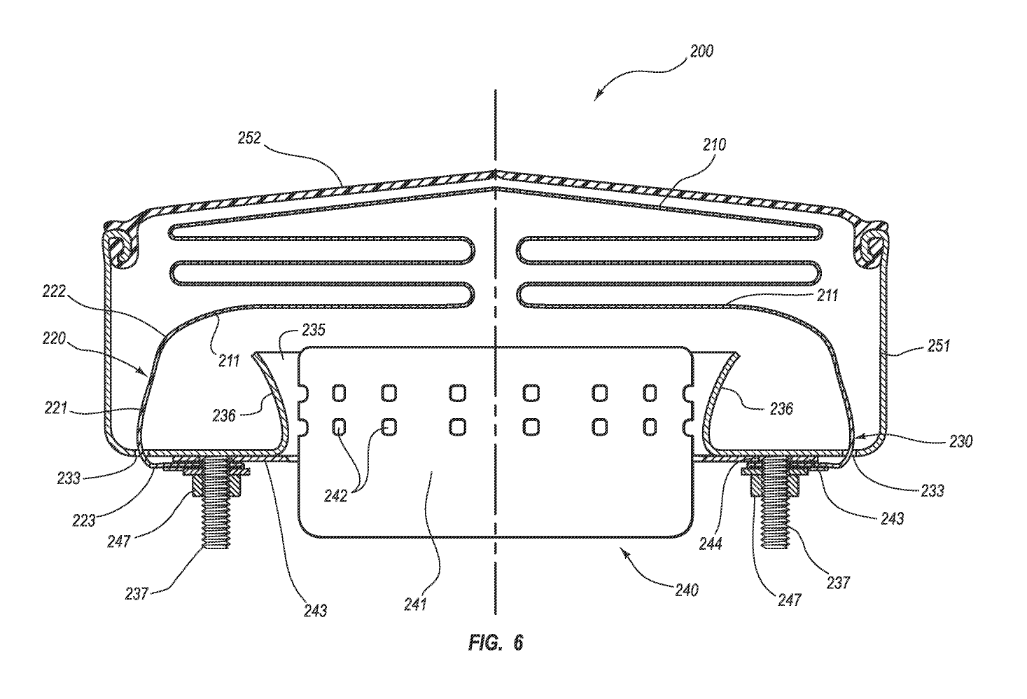

In the depiction of FIG. 5, cushion membrane 110 and inflator 140 are appropriately positioned and are ready to be fixedly coupled to the attachment interface via mounting hardware such as threaded nuts. Similar to the depiction of assembly 200 in FIG. 6, cushion membrane 110 may be folded and/or rolled into a packaged configuration and placed within attachment interface 130. Further, a cosmetic cover may be coupled to side walls of the attachment interface.

FIG. 6 is a side elevation cross section view of another embodiment of an airbag assembly 200, which may comprise an airbag cushion membrane 210, an attachment interface 230, an inflator 240, mounting hardware 247, and a cosmetic cover 252. In the depiction of FIG. 6, airbag cushion membrane 210 and inflator 240 have been coupled to an attachment interface 230. Assembly 200 may be configured similarly to and may function similarly as airbag assembly 100, except where the following description of assembly 200 varies from the previous description of assembly 100.

Cushion membrane 210 comprises a throat portion 211 and a plurality of mounting flaps 220, wherein the flaps comprise a body portion 221, a base portion 222, and an end portion 223, and a plurality of apertures 224. Attachment interface 230 may comprise a plurality of slots 233, a gas inlet opening 235, a plurality of deflectors 236, a plurality of mounting stems 237, and side walls 251. Attachment interface walls 251 may comprise 4 side walls that are contiguous extensions of attachment interface 230. Walls 251 may form a generally rectangular or square shape, and are of a predetermined length such that cushion membrane 210 may be received within the side walls and a cosmetic cover 252 coupled to the walls. Inflator 240 may comprise a body portion 241, a plurality of gas vents 242, a plate portion 243, and a plurality of mounting apertures 244.

FIG. 6 depicts an assembled airbag assembly 200, which may comprise additional mounting structures or hardware that are configured to allow the assembly to be fixedly coupled to a vehicle structure. In the depicted embodiment attachment interface 230 comprises a planar rear face. Apertures 243, formed in plate portion 244 of inflator, have been placed over attachment interface mounting stems 237. Cushion membrane 210 flaps 220 comprise a contiguous extension of the cushion membrane, such that there is not demarcation between the throat portion 211 of the cushion and base portions 222 of the flaps. Body portions 221 pass through slots 233 in the attachment interface and mounting apertures (not visible) in end portions 223 of the flaps surround mounting stems 237. Threaded nuts with integrated washers 247 fixedly couple cushion membrane flaps 120 and inflator 140 to attachment interface 230.

One skilled in the art will recognize that in the packaged state, a deployment flap and/or wrapper may be disposed between the inflatable cushion membrane and a top portion of the housing, which may comprise a cosmetic cover. During airbag deployment, the deployment flap may function to protect the cushion membrane from damage caused by the housing, cosmetic cover edges, or other structures disposed near the housing and in the path of the deploying cushion membrane. Further, the side walls of the attachment interface may not form a rectangular or square shape.

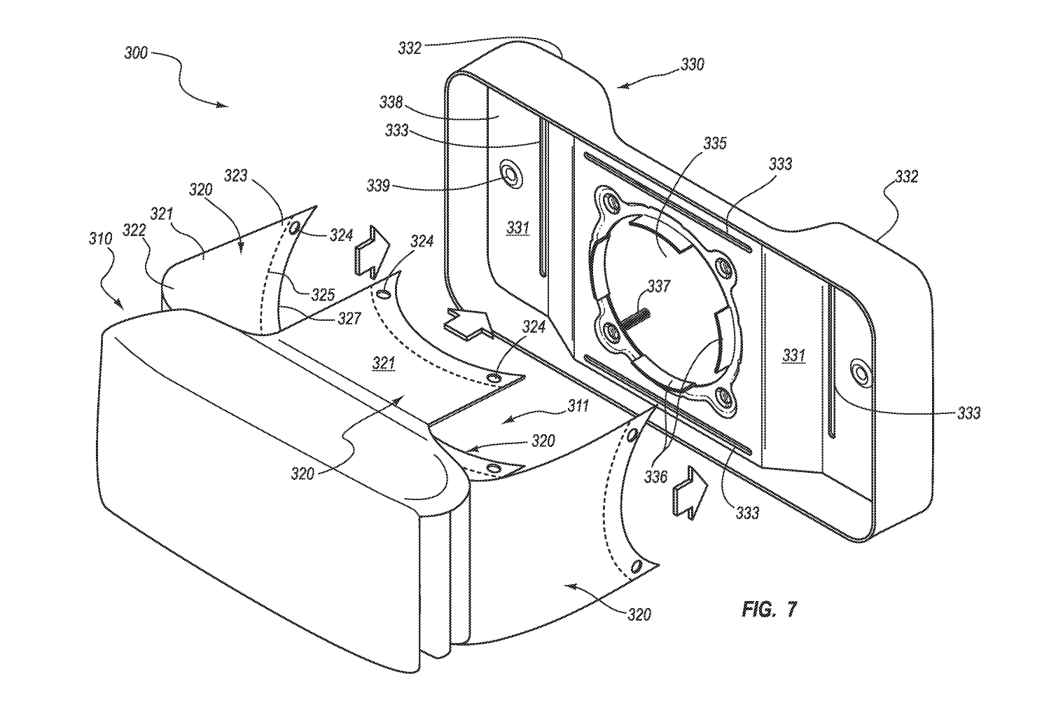

FIG. 7 is a perspective view of an airbag assembly 300, wherein the assembly comprises an inflatable airbag cushion membrane 310 and an attachment interface 330. Assembly 300 may be configured similarly to and may function similarly as airbag assemblies 100 and 200, including being configured to be used with an inflator and a cosmetic cover. Cushion membrane 310 may comprise a throat portion 311 and four flaps 320. Attachment inter face 330 may comprise a front face 331, a rear face 332, four slots 333, a gas inlet opening 335, a deflector 336, a plurality of mounting stems 337, one or more topographical features 338, and one or more mounting structures 339.

Each of the four cushion membrane flaps 320 are configured to be received by one of the slots 333, and may comprise a body portion 321, a base portion 322, an end portion 323, a terminal portion 327, a plurality of apertures 324, and stitching 325. Apertures 324 are configured to be received by mounting stems 337 after flaps 320 have been slid through slots 333. As described above, an inflator may be coupled to the attachment interface before flaps 320 are received by mounting stems 337.

The inflatable cushion membranes, attachment interfaces, and inflators disclosed herein and depicted in the accompanying figures may be employed in a method for coupling an airbag cushion membrane to an airbag attachment interface. The method may comprise the steps of providing an inflatable airbag cushion membrane that comprises a plurality of attachment flaps with a plurality of apertures, providing an attachment interface that comprises a plurality of slots, a plurality of apertures, and a plurality of mounting stems, placing the attachment flaps through the slots, providing an inflator with a body portion, a plate portion, and a plurality of mounting apertures, aligning the inflator apertures with their complementary attachment interface mounting stems, placing the attachment interface mounting stems through the plurality of apertures on the inflator, folding the attachment flaps flat across a rear face of the attachment interface, placing the plurality of apertures over the plurality of mounting stems, and securing the cushion flaps and inflator to the mounting interface using mounting hardware that is complementary to the attachment interface mounting stems.

Methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Without further elaboration, it is believed that one skilled in the art can use the preceding description to utilize the present disclosure to its fullest extent. The examples and embodiments disclosed herein are to be construed as merely illustrative and not a limitation to the scope of the present disclosure in any way. It will be apparent to those having skill in the art that changes may be made to the details of the above-described embodiments without departing from the underlying principles of the disclosure described herein. In other words, various modifications and improvements of the embodiments specifically disclosed in the description above are within the scope of the appended claims. Note that elements recited in means-plus-function format are intended to be construed in accordance with 35 U.S.C. §112 ¶6. The scope of the disclosure is therefore defined by the following claims.

1. An airbag assembly comprising:
an inflatable cushion membrane having a plurality of flaps, wherein each flap has a plurality of apertures;
an attachment interface configured to allow the cushion membrane to be anchored to the attachment interface via the plurality of apertures in the flaps;
an inflator having a plurality of apertures, wherein the inflator is configured to be coupled to the attachment interface such that the flaps are located between the attachment interface and the inflator.

2. The airbag assembly of claim 1, wherein the plurality of apertures in each of the cushion membrane flaps comprises a plurality of attachment interface mounting stem receiving apertures.

3. The airbag assembly of claim 1, wherein the plurality of flaps are identical to each other such that each has the same shape, number of apertures, and distribution of apertures.

4. The airbag assembly of claim 1, wherein the plurality of flaps comprise two flaps.

5. The airbag assembly of claim 1, wherein the plurality of flaps comprise four flaps.

6. The airbag assembly of claim 1, wherein the flaps comprise semicircular terminal portions.

7. The airbag assembly of claim 1, wherein the flaps comprise pieces of material that are originally separate from the inflatable cushion membrane and are coupled to the membrane.

8. The airbag assembly of claim 1, wherein the flaps comprise integral extensions of the inflatable cushion membrane.

9. The airbag assembly of claim 1, wherein the flaps comprise at least two layers of material that are coupled together.

10. An inflatable airbag assembly, comprising:
an inflatable cushion membrane having a plurality of flaps that extend away from the membrane, wherein each flap comprises;
a base portion that abuts the inflatable cushion membrane,
a body portion, and
an end portion having a plurality of apertures;
an attachment interface comprising a plurality of apertures and a plurality of mounting stems that project away from a rear face of the attachment interface, wherein the attachment interface is configured to allow the cushion membrane to be anchored to the attachment interface by receiving the plurality of cushion membrane flaps through some of the apertures in the attachment interface and by placing each of the apertures in the flap onto one mounting stem on the attachment interface; and,
an inflator having a plate portion with a plurality of apertures for mounting, wherein the inflator is configured to be coupled to the attachment interface such that a portion of each of the flaps is located between the inflator plate and a piece of mounting hardware.

11. The airbag assembly of claim 10, wherein the apertures in the attachment interface comprise:
elongated slots for receiving the cushion membrane flaps;
a gas inlet opening; and,
apertures for receiving one or more components that allow the attachment interface to be mounted to a vehicle structure.

12. The airbag assembly of claim 11, wherein each of the elongated slots are greater than 50% of the height of the attachment interface.

13. The airbag assembly of claim 10, wherein the mounting stems on the attachment interface are configured to receive the mounting apertures in the inflator.

14. The airbag assembly of claim 10, wherein the attachment interface comprises one or more topographical features.

15. The airbag assembly of claim 14, wherein the one or more topographical features allow the attachment interface to be mounted to, or received within a predetermined vehicle environment.

16. The airbag assembly of claim 10, wherein the airbag membrane comprises two flaps and the attachment interface comprises two slots for receiving the flaps.

17. The airbag assembly of claim 10, wherein the airbag membrane comprises four flaps and the attachment interface comprises four slots for receiving the flaps.

18. The airbag assembly of claim 17, wherein the four slots in the attachment interface are arranged in a pattern that forms a square shape.

19. The airbag assembly of claim 10, wherein the slots for receiving the flaps are located further away from the gas inlet opening than the stems on the attachment interface that are configured to receive the flap apertures and the mounting apertures in the inflator.

20. The airbag assembly of claim 10, wherein the attachment interface comprises one or more deflectors that are contiguous extensions of the attachment interface, and wherein the deflectors project away from a front face of the attachment interface and are arranged around the gas inlet opening.

21. An assembled airbag module comprising:
a packaged inflatable cushion membrane comprising a plurality of flaps that extend away from the cushion membrane, an attachment interface, an inflator, and a housing, wherein a base portion of each of the flaps abuts a front face of the attachment interface, a body portion of each of the flaps protrude through elongated slots in the attachment interface, an end portion of each of the flaps lies substantially parallel with a rear face of the attachment interface and extends inwardly toward a gas inlet opening in the attachment interface,
wherein the end portion of each of the flaps have a plurality of apertures, which envelop mounting stems that are attached to the attachment interface and extend away from the rear face of the interface in a direction that is opposite the front face,
wherein the attachment interface comprises a housing that forms an interior void, within which is located the packaged cushion membrane.

22. The airbag assembly of claim 21, wherein the cushion membrane comprises two flaps and the attachment interface comprises two slots that receive the flaps.

23. The airbag assembly of claim 21, wherein the cushion membrane comprises four flaps and the attachment interface comprises four slots that receive the flaps.

24. The airbag assembly of claim 23, wherein the four slots in the attachment interface are arranged such that they form a square pattern.

25. A method for coupling an inflatable cushion membrane to an attachment interface, comprising:
providing an inflatable airbag cushion membrane having plurality of attachment flaps;
providing an attachment interface that comprises a plurality of slots;
placing each attachment flap through a slot;
folding the attachment flaps across a rear face of the attachment interface in the direction of a gas inlet opening; and,
securing the attachment flaps to the attachment interface.

26. The method of claim 25 further comprising:
providing an inflator with a body portion and a plate portion;
aligning mounting apertures on the inflator with complementary mounting extensions on the attachment interface; and,
securing the inflator to the mounting interface with mounting hardware that is complementary to a portion of the mounting extensions on the attachment interface.
